(19) United States
(12) Patent Application Publication
(10) Pub. No.: US 2019/0001476 A1
(43) Pub. Date: Jan. 3, 2019

(54) IRRIGATION STAPLE DEVICE AND RELATED METHODS

(71) Applicant: Caleb Medefind, SNELLING, CA (US)

(72) Inventor: Jose Ponce-Gutierrez, Snelling, CA (US)

(21) Appl. No.: 15/635,861

(22) Filed: Jun. 28, 2017

(51) Int. Cl. B25C 5/13; B25G 1/10; A01G 25/02

(52) U.S. Cl. CPC B25C 5/13; A01G 25/02; B25G 1/102

(57) ABSTRACT

The present invention provides an irrigation staple insertion device and method for setting staples to secure flexible tubing to the ground. The device offers significant advancements toward the prevention of deformation of the tubing from driving the staples too far into the ground, and alleviates the need for an installer to bend down to install each staple. The staple insertion device may include a piston nested within an outer chamber, where the outer chamber includes a slot for holding an irrigation staple to be inserted into the ground over an irrigation tube. The piston may be structured and nested in the outer chamber such that it can only travel a pre-determined distance through the chamber that is equal to the length of the staple less the thickness of the irrigation tube.

### FIELD OF THE INVENTION

The present invention relates to an apparatus and method for securing irrigation lines, and specifically to a device and method for stapling an irrigation tube to the ground.

### DISCUSSION OF THE BACKGROUND

Drip irrigation systems have quickly become an industry standard for the irrigation of tree, row, and forage crops in arid environments. As water shortages and the drought continue to worsen, it has become more valuable for farmers to utilize every drop of irrigation water to the greatest extent possible. Due to the low volume of water used in drip irrigation, accurate placement of irrigation tubes is essential to ensure the growth and development of trees and crops. Animals, wind, rain, and farm equipment may knock irrigation tubes out of place, however, causing many growers to utilize a securing device to keep the irrigation tubes in place in the soil.

Existing systems and methods for securing irrigation tubes in place include large staples which fit over the irrigation tube. These staples are typically installed with a hammer or long pole with a simple slot at the end for holding a staple. Use of a hammer is undesirable because the installer must bend down and use two hands to install each staple, consuming time and causing discomfort as the installer may be securing thousands of feet of irrigation tubes. Further, the person driving the staples into the ground can easily apply excess force, driving the staple too far into the ground and causing a kink in the irrigation tube.

Use of a pole with a staple slot may relieve the installer from having to bend down to install each staple, but this system does not solve the problem of driving the staple too far into the ground, thereby deforming the irrigation tube. A kink at the proximal end of a long irrigation tube can reduce water pressure and delivery, and may cause perforations in the irrigation tube.

Therefore, what is desired is a device which allows the installer to remain standing as the staples are installed and prevents the staples from being driven too far and deforming the irrigation tube, thus increasing the speed and comfort of the installer and preventing decreased water delivery to crops.

### SUMMARY OF THE INVENTION

The present invention provides an irrigation staple insertion device and method for setting staples to secure flexible tubing to the ground. The device offers significant advancements to the prevention of deformation of the tubing from driving the staples too far into the ground, and alleviates the need for an installer to bend down to install each staple. The staple insertion device may include a piston nested within an outer chamber, where the outer chamber includes a slot for holding an irrigation staple to be inserted into the ground over an irrigation tube. The piston may be structured and nested in the outer chamber such that it can only travel a pre-determined distance through the chamber that is equal to the length of the staple less the thickness of the irrigation tube (e.g., one inch irrigation tube). As a result, the staples can inserted into the ground consistently such that they sit over the irrigation tubing without pinching it, regardless of the force the user applies to the piston to drive the staple into the ground. Thus, staples can be driven into hard pan as well as soft soil without damaging the irrigation tubing.

The device may comprise: a chamber with a proximal end and a distal end and having a staple slot in the distal end, a piston nested within the chamber and having a proximal end and a distal portion, and a spring with a proximal end and a distal end, the spring positioned between the piston and the chamber. A method for using the irrigation staple device may comprise fitting a staple in the slot in the distal end of the chamber, positioning the staple device over an irrigation tube, and driving the proximal end of the piston downward.

The chamber may comprise a substantially cylindrical or tubular shape with a proximal end and a distal end and a cylindrical cavity therein. The proximal end may receive the distal portion of the piston through the cylindrical cavity, and may thus have an inner diameter that is slightly greater than the outer diameter of a distal portion of the piston. The distal end of the chamber may include a staple slot for inserting an irrigation staple. The slot may have a depth that allows the staple to be nested within the distal end of the chamber such that only a pre-determined length of the staple protrudes from the staple slot. The staple slot may include a proximal barrier within the cylindrical chamber to prevent the staple from moving farther into the cylindrical chamber. In some examples, the staple may be inserted to an outwardly bowing protrusion along the leg of the staple, which is found in some irrigation staples. In other examples, the pre-determined length equal to the thickness of the irrigation tubing. In all embodiments of the present invention, the predetermined distance represents a substantial portion of the length of the staple (e.g., the majority of the length of the staple). The positioning of a substantial portion or majority of the staple prevents the legs of the staple from undesirably spreading as the staple is inserted into the soil, especially in the case of hard pan soil. The protrusion of a portion of the staple from the distal end of the chamber is also beneficial because the distal ends of the staple can be used to straddle the irrigation tubing and move it into a desired position or location, without the user needing to bend down and move the irrigation tubing by hand.

In some embodiments, the chamber may have two diametric guides that are aligned with the staple slot such that the portion of staple legs protruding from the end of the staple slot are engaged with the guides. The guides may have lengths equal to the protruding portions of the legs of the irrigation staple when the staple is fully inserted into the staple slot (e.g., equal to the diameter of the irrigation tubing—about 1 inch). The guides may aid in positioning the staple insertion tool over the irrigation tubing, in preventing the irrigation staple from pinching the irrigation tube by spacing the distal end of the chamber at a distance equal to the portion of the irrigation staple that should protrude from the soil, and in moving the irrigation tubing into a desired position or location.

In some embodiments, the proximal end of the chamber may comprise an upper shoulder having an annular surface that abuts the distal end of the spring when the staple insertion device is assembled. In some embodiments, the lower end of the spring may be attached to the upper shoulder of the chamber. In some embodiments, the proximal end of the chamber may comprise an outer handle for providing better grip to the installer. In some embodiments, the outer handle may comprise an ergonomic shape complementary to a shape of the installer's hand.

In some embodiments, the staple device may be capable of holding a plurality of staples, and automatically positioning a new staple in the chamber after the prior staple is set in the ground. For example, and without limitation, the cylindrical chamber may comprise a housing for holding a plurality of staples, the housing comprising an opening for depositing the plurality of staples, a channel for holding and directing the plurality of staples toward the staple guide, and a lateral spring to push the plurality of staples along the channel and toward the staple guide. In some embodiments, as the distal end of the piston retreats back away from the second end of the chamber after driving a first staple of the plurality of staples into the ground, the lateral spring may push a second staple of the plurality of staples into position in the staple guide, allowing the staple device to set the second staple without the installer having to place the second staple into the staple guide manually.

In some embodiments, the second end of the chamber may comprise a staple guide for placing a staple in the second end, and holding the staple in a position substantially parallel to a central axis of the chamber. In some embodiments, the staple guide may comprise two grooves in an inner surface of the second end, the grooves being positioned on opposite sides of the inner surface. Embodiments of the staple guide may comprise a terminal abutment, the terminal abutment being positioned to prevent the staple from moving farther into the chamber. In some embodiments, the terminal abutment may be positioned such that the legs of the staple extend out of the second end of the chamber, allowing the legs to be placed on either side of an irrigation tube prior to driving the staple into the ground. In other embodiments, the staple guide may not comprise the terminal abutment, and the staple may be prevented from moving further into the chamber as the crossbar of the staple comes into contact with the distal end of the piston.

The piston may comprise a distal portion having a substantially cylindrical shape with an outer diameter that is slightly smaller than the inner diameter of the cylindrical chamber, and a proximal portion having a greater diameter than the inner diameter of the cylindrical chamber. The distal portion may be operable to be nested within the cylindrical chamber and slide through the cylindrical chamber toward a staple positioned in the staple slot when the insertion tool is being used. The distal portion of the piston may have a length that is equal to or slightly less than the length of the cylindrical chamber, such that the distal portion can penetrate the cylindrical chamber down to its distal end or near its distal end where the crown of the irrigation staple is positioned at the proximal end of the staple slot. The distal end of the distal portion of the piston may have a blunt surface for contacting the crown of the irrigation staple positioned in the staple slot. In some embodiments the distal end may be concave with a curvature that is complementary or about complementary to the typically convex curvature of conventional irrigation staples.

The proximal portion of the piston may comprise an outer diameter greater than both an outer diameter of the distal portion of the piston, and an inner diameter of the cylindrical chamber, such that the distal portion of the piston fits into the chamber and the proximal end does not. In some embodiments, the proximal end may comprise a lower shoulder with an annular surface that abuts the proximal end of the spring when the staple insertion device is assembled. In some embodiments, the proximal end of the spring may be attached to the lower shoulder of the piston.

The piston may include a handle at its proximal end to allow the user to easily grip the piston. During use of the piston, the user may drive the piston through the cylindrical chamber against the resistance of the spring by pushing the piston handle downward when the staple insertion device is position over an irrigation line. In some embodiments, the handle may comprise a substantially hemispherical shape or other shape that is roughly complementary to and/or comfortable in the shape of a palm of an installer's hand.

The spring may be a helical coil with a proximal end in contact with the shoulder of the proximal portion of the piston, and a lower end in contact with the shoulder of the proximal end of the chamber. The spring may provide a force to keep the proximal end and the first end apart at a resting length. In some embodiments, the spring may be removably attached to both the shoulder of the proximal portion of the piston and the shoulder of the proximal end of the chamber. In some embodiments, when the piston is driven toward the ground by the installer, the spring may be compressed from a resting length to a compressed length. In some embodiments, as the spring reaches the compressed length, the spring may prevent the piston from traveling farther into the chamber, thus preventing the staple from traveling farther into the ground than a pre-determined distance. Thus, the difference between the resting length and the compressed length of the spring may define a pre-determined stroke length of the piston. In other embodiments the stroke length may be longer than the spring. For example, the stroke length may be defined by a catch mechanism between the piston and passage that limits the distance the piston can be drawn out of the passage. For example, the piston may include a pawl, pin, tine, or other protrusion that nests within a slot that runs along the passage and has a predetermined length that prevents the piston from being drawn out of the passage beyond a pre-determined point to thereby define the stroke length of the piston. In such embodiments, the spring is contacted only during a portion of the stroke length and may function to decelerate the piston at the latter part of the piston stroke in order to reduce the force applied to staple after the staple has penetrated the ground and is approaching the upper surface of the irrigation tubing to avoid pinching. The stroke length of the piston may thus be calculated to allow the staple device to drive a staple into the ground without pinching the irrigation tube.

In some embodiments, the spring may be a compound spring having at least two stages, each stage having a different spring constant. The compound spring may be used to decelerate the piston at the latter part of the piston stroke in order to reduce the force applied to staple after the staple has penetrated the ground and is approaching the upper surface of the irrigation tubing. For example, the spring may include a first stage at its proximal end having a first spring constant and a second portion at its distal end having a second spring constant that is greater than the first spring constant. In this example, the second stage has a higher spring constant requiring more applied force to move a given distance, which causes the piston to slow down as the piston compresses the more distal second stage of the spring. As a result the piston slows down as the crown of the staple becomes closer to the irrigation tubing. In some examples, the first spring constant may be in a range of about 10% to about 90% of the second spring constant (e.g., in a range of about 25% to about 75%, about 30% to about 60%, or any value or range of values therein). In further embodiments, the spring may have three or more stages, each having different spring constants (e.g., successively larger spring constants). The separate stages of the spring may be fused directly together in succession, or they may be interconnected by separating rings located between each successive pair of spring stages.

Several embodiments are discussed below, but the example embodiments shall not be interpreted as an exhaustive list. One with ordinary skill in the art will recognize that the scope of the present invention includes further variations and equivalents to the specific examples described herein.

In one implementation, the present invention relates to a device for driving a staple into the ground, the device comprising: a piston with a proximal end and a distal end; a chamber with a first end and a second end; and a spring with an upper end and a lower end positioned between the piston and the chamber. In one implementation, a distance the staple is driven into the ground is defined by a stroke length of the piston. In one implementation, the proximal end comprises an outer diameter greater than an outer diameter of the distal end, and greater than an inner diameter of the first end, the distal end being positioned substantially inside the chamber. In one implementation, the upper end of the spring is in contact with the proximal end and the lower end of the spring is in contact with the first end. In one implementation, the stroke length is defined by a difference between a resting length of the spring and a compressed length of the spring. The stroke length may be defined by the difference between a relaxed length of the spring and a compressed length of the spring. In one implementation, the proximal end comprises a handle. In one implementation, the first end comprises an outer handle. In one implementation, the second end comprises a staple guide. In one implementation, the staple guide comprises two grooves in an inner surface of the chamber, the two grooves being positioned on opposite sides of the inner surface and each being capable of holding a leg of the staple substantially parallel with a central axis of the chamber. In one implementation, the staple guide comprises a terminal abutment to prevent a crossbar of the staple from moving past the terminal abutment, the terminal abutment being positioned such that each of the legs extend out of the second end of the chamber, allowing the legs to be positioned on both sides of an irrigation tube prior to driving the staple into the ground. In one implementation, the chamber comprises at least one foot, the foot comprising a length substantially equal to an outer diameter of an irrigation tube. In one implementation, the chamber comprises two feet positioned on opposite sides of the second end, each foot of the two feet comprising a length substantially equal to an outer diameter of an irrigation tube, and each foot of the two feet being positioned to align with a groove of the two grooves of the staple guide. In one implementation, the chamber comprises a housing for holding a plurality of staples. In one implementation, the housing comprises an opening, a lateral spring, and a channel. In one implementation, the lateral spring pushes the plurality of staples inward toward the a staple guide, such that when a first staple of the plurality of staples is driven into the ground and the piston is released to a resting position, a second staple of the plurality of staples is pushed into the staple guide. In one implementation, the device comprises at least one foot, the foot comprising a length substantially equal to an outer diameter of an irrigation tube.

In one implementation, the present invention relates to a method comprising the steps of: positioning an irrigation tube on the ground; positioning the staple in the second end of the chamber; positioning the staple device over the irrigation tube; and driving the proximal end of the piston downward. In one implementation, the method further comprises the steps of: positioning a second staple in the second end; repositioning the staple device over the irrigation tube; and driving the proximal end of the piston downward. In one implementation wherein the staple device comprises the housing, the method for using the staple device comprises the steps of: positioning an irrigation tube on the ground; positioning the plurality of staples in the housing; positioning the staple device over the irrigation tube; and driving the proximal end of the piston downward. In one implementation, the method further comprises the steps of: repositioning the staple device over the irrigation tube; and driving the proximal end of the piston downward.

In some embodiments, the spring may have a plurality of stages, each stage comprising a different spring constant. The plurality of stages may have a first stage having a first spring constant, and a second stage having a second spring constant, the second spring constant being greater than the first spring constant. The first stage and the second stage of the spring may be separated by a separating ring. The spring may have a plurality of stages, each stage comprising a different spring constant. In some implementations, the stroke length of the device may be defined by the difference between a relaxed length of the spring and a compressed length of the spring, the relaxed length being the sum of a relaxed length of the first stage and a relaxed length of the second stage, and the compressed length being the sum of a compressed length of the first stage and a compressed length of the second stage.

In some embodiments, the invention relates to a device for driving a staple into the ground, the device comprising a piston with a proximal portion and a distal portion; a barrel with a proximal end and a distal end, and a passage in which the distal portion of the piston is slidably positioned, the barrel having a slot positioned the distal end for positioning a staple for holding an irrigation tube to the ground; and a cushioning mechanism positioned between the proximal portion of the piston and the proximal end of the barrel. The distance of the staple is driven into the ground is defined by a stroke length of the piston. The proximal portion of the piston comprises a shoulder may have an outer diameter greater than an outer diameter of the distal portion, and greater than an inner diameter of the passage. The cushioning mechanism may prevent the piston from advancing beyond a pre-determined point in the barrel. The slot may include two grooves in an inner surface of the passage, the two grooves being positioned on opposite lateral sides of the inner surface of the passage and each being capable of holding a leg of the staple in substantial alignment with a central axis of the chamber. The slot may comprise at least one terminal abutment to prevent a crown of the staple from moving past a pre-determined position in the barrel, the terminal abutment being positioned such that each of the legs extend out of the distal end of the chamber, allowing the legs to be positioned on both sides of an irrigation tube prior to driving the staple into the ground. The chamber may comprise at least one spacer foot, the spacer foot comprising a length substantially equal to an outer diameter of an irrigation tube. The barrel may comprise two spacer feet positioned on opposite sides of the distal end, each of the two feet comprising a length substantially equal to an outer diameter of an irrigation tube, and each of the two feet being positioned to align with a groove of the two grooves of the staple guide. The chamber may comprise a housing for holding a plurality of staples to be sequentially loaded into the staple slot. The housing may comprise an opening, a lateral spring, and a channel.

In some embodiments, the invention may relate to device for driving a staple into the ground, the device comprising a staple driving mechanism that includes a staple driver having a staple driving portion and a handle; a barrel with a proximal end and a distal end, and a passage in which the staple driving portion is slidably positioned, the barrel having a slot positioned the distal end for positioning a staple for holding an irrigation tube to the ground; and a cushioning mechanism positioned between the staple driving portion of the staple driver and the proximal end of the barrel that prevents the driving portion from penetrating the passage beyond a pre-determined point in the barrel. The distance the staple is driven into the ground may be defined by a stroke length of the piston. The slot may comprise two grooves in an inner surface of the passage, the two grooves being positioned on opposite lateral sides of the inner surface of the passage and each being capable of holding a leg of the staple in substantial alignment with a central axis of the chamber. The slot may comprise at least one terminal abutment to prevent a crown of the staple from moving past a pre-determined position in the barrel, the terminal abutment being positioned such that each of the legs extend out of the distal end of the barrel, allowing the legs to be positioned on both sides of an irrigation tube prior to the staple being driven into the ground. The chamber may comprise at least one spacer foot, the spacer foot comprising a length substantially equal to an outer diameter of an irrigation tube. The barrel may comprise two spacer feet positioned on opposite sides of the distal end, each of the two feet comprising a length substantially equal to an outer diameter of an irrigation tube, and each of the two feet being positioned to align with a groove of the two grooves of the staple guide. The chamber may comprise a housing for holding a plurality of staples to be sequentially loaded into the staple slot. The housing may comprise an opening, a lateral spring, and a channel.

It is an objective of the present invention to provide a device and method for setting staples over an irrigation tube without pinching the tube.

It is a further objective of the present invention to provide a device and method for setting staples over an irrigation tube without the installer having to bend down to set each staple.

Additional aspects and objects of the invention will be apparent from the detailed descriptions and the claims herein.

### BRIEF DESCRIPTION OF THE DRAWINGS

FIG. 1A shows a side view of an irrigation staple device, according to an embodiment of the present invention.

FIG. 1B shows a bottom view of an irrigation staple device, according to an embodiment of the present invention.

FIG. 2 shows a cross-section view of an irrigation staple device setting a staple, according to an embodiment of the present invention.

FIG. 3 shows a cross-section view of an irrigation staple device setting a staple, according to an embodiment of the present invention.

FIG. 4 shows a cross-section view of an irrigation staple device setting a staple, according to an embodiment of the present invention.

FIG. 5A shows a side view of an irrigation staple device setting a staple, according to an embodiment of the present invention.

FIG. 5B shows a side view of an irrigation staple device setting a staple, according to an embodiment of the present invention.

FIG. 5C shows a side view of an irrigation staple device setting a staple, according to an embodiment of the present invention.

### DETAILED DESCRIPTION OF THE EXEMPLARY EMBODIMENTS

Reference will now be made in detail to certain embodiments of the invention, examples of which are illustrated in the accompanying drawings. While the invention will be described in reference to these embodiments, it will be understood that they are not intended to limit the invention. Conversely, the invention is intended to cover alternatives, modifications, and equivalents that are included within the scope of the invention as defined by the claims. In the following disclosure, specific details are given as a way to provide a thorough understanding of the invention. However, it will be apparent to one skilled in the art that the present invention may be practiced without these specific details.

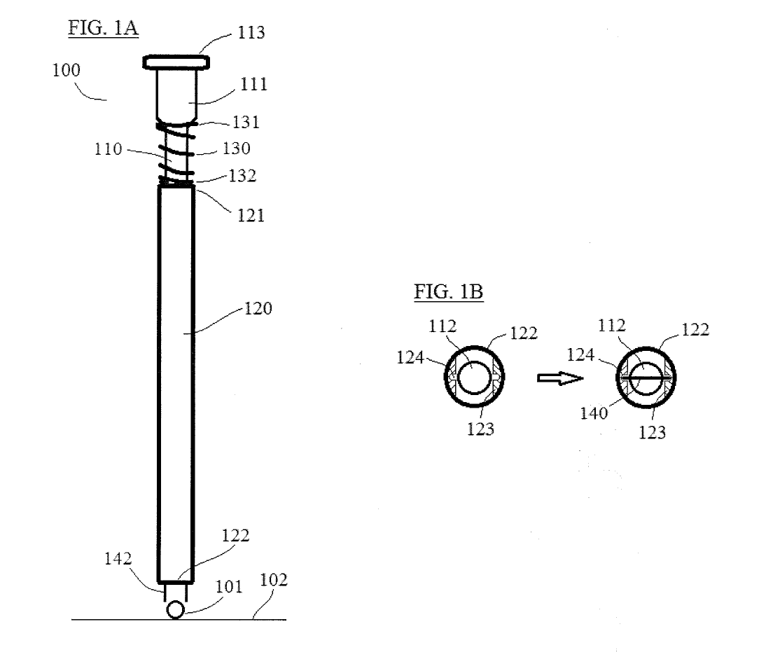

Referring to the drawings, wherein like reference characters designate like or corresponding parts throughout the several views, and referring particularly to FIGS. 1A-4D, it is seen that the present invention includes various embodiments of an irrigation staple device for installing irrigation tubing in an orchard or other agricultural, gardening, or other applications.

Without limiting the invention, FIG. 1A illustrates a side view of an irrigation staple device 100, and FIG. 1B illustrates a bottom view of the irrigation staple device. In some embodiments, the irrigation staple device 100 may comprise: a piston 110 with a proximal portion 111 and a distal portion 112, the proximal portion 111 having a handle 113; a chamber 120 having an cylindrical passage 120a therein running from a proximal end 121 thereof to a distal end 122 thereof. The distal end 122 having a staple guide 123 with grooves 124 for holding a staple 140; and a spring 130 with a proximal end 131 and a distal end 132, the spring 130 being positioned between the piston 110 and the chamber 120. A staple 140 may be positioned in the staple guide 123 in the second end 122 of the chamber 120, the staple 140 comprising a crown 141 and legs 142 which extend out of the distal end 122 such that the legs 142 may be fitted over an irrigation tube 101 on the ground 102 prior to setting the staple 140.

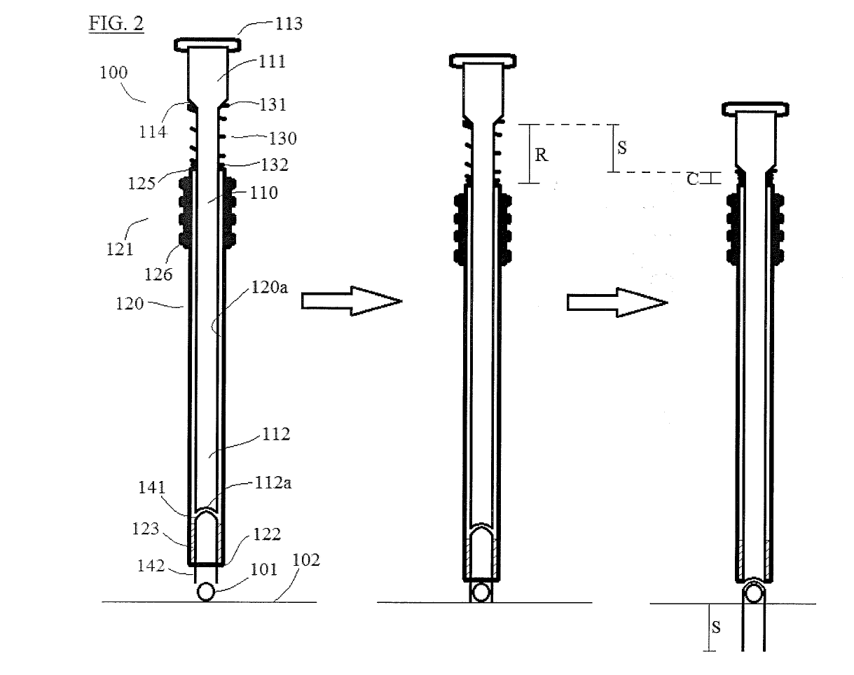

Without limiting to the invention, FIG. 2 illustrates cross-section views of an embodiment of an irrigation staple device 100 and a method for using the irrigation staple device 100. The piston 110 may comprise a substantially cylindrical shape, a proximal portion 111 with a handle 113, and a distal portion 112 for contacting a staple 140. In some embodiments, the proximal portion 111 may comprise an outer diameter greater than both an outer diameter of the distal portion 112, and an inner diameter of the cylindrical chamber 120a, such that the distal end 112 of the piston 110 fits into the cylindrical passage 120a and the proximal portion 111 does not. In some embodiments, the proximal portion 111 may comprise a lower shoulder 114 that may abut the upper end 131 of the spring 130, such that the upper end 131 may fit against the lower shoulder 114. In some examples, the lower shoulder may have an oblique slope between the proximal portion 111 and the distal portion 112. In some embodiments, the upper end 131 of the spring 130 may be attached to the lower shoulder 114. In some embodiments, the distal portion 112 of the piston 110 may have a distal end 112a that has a shape complementary to the shape of a crossbar 141 of the staple. For example, the distal end 112a may be concave with a curvature that complements a curved crown of the irrigation staple.

The chamber 120 may comprise a substantially tubular shape with a proximal end 121 and a distal end 122. In some embodiments, the cylindrical passage 120a may comprise a diameter sufficiently greater than an outer diameter of the distal portion 112 of the piston 110 to allow the distal portion 112 to fit into and move freely along the cylindrical passage 120a, and a consistent and narrow path for the distal portion 112 to substantially maintain the movement of the distal portion 112 along the longitudinal axis of the cylindrical passage 120a. In some embodiments, the first end 121 of the chamber 120 may comprise an upper shoulder 125 that may abut a lower end 132 of the spring 130, where the lower end 132 may be substantially concentrically aligned with the upper shoulder 125. In some embodiments, the lower end 132 may be attached to the upper shoulder 125 of the chamber. In some embodiments, the chamber 120 may comprise an outer handle 126 for providing better grip to an installer. In some embodiments, the outer handle 126 may comprise an ergonomic shape complementary to a shape of the installer's hand.

Embodiments of the spring may 130 comprise a helical coil with an upper end 131 in contact with the proximal end 111 of the piston 110, and a lower end 132 in contact with the first end 121 of the chamber 120. In some embodiments, the spring 130 may be removably attached to both the proximal end 111 and the first end 121. The spring 130 may provide a force to keep the proximal end 111 and the first end 121 apart at a resting length R. In some embodiments, when the piston 110 is driven toward the ground 102 by the installer, the spring 130 may be compressed from the resting length R to a compressed length C. In some embodiments, as the spring 130 reaches the compressed length C, the spring 130 may prevent the piston 110 from traveling farther into the chamber 120, thus preventing the staple 140 from traveling farther into the ground 102. Thus, the difference between the resting length R and the compressed length C of the spring 130 may define the stroke length S of the piston 110. The stroke length S of the piston 110 may thus be calculated to allow the staple device 100 to drive a staple 140 into the ground 102 a predetermined distance (e.g., the stroke length S), so as not to pinch the irrigation tube 101. The stroke length S may be equal to the difference between the length of the staple and the diameter of the irrigation tube or less. For example, stroke length may be about 50% to about 100% of the difference between the length of the staple and the diameter of the irrigation tube (e.g., about 70% to about 90%, or any value or range of values therein).

In some embodiments, the second end 122 may comprise a staple guide 123 for placing a staple 140 in the second end 122, and holding the staple 140 in a position substantially parallel to a central axis of the chamber 120. In some embodiments, the staple guide 123 may comprise two grooves 124, the grooves 124 being positioned on opposite sides of the cylindrical passage 120a. In some embodiments, the staple 140 may be prevented from moving further into the cylindrical passage 120a as the distal end 112a of the piston 110 comes into contact with the crown 141.

A method for using the irrigation staple device 100 may comprise the steps of: fitting a staple 140 into the staple guide 123, the legs 142 extending out of the second end 122 to guide placement of the second end 122 over an irrigation tube 101; positioning the staple device 100 over an irrigation tube 101, the irrigation tube 101 being positioned at a predetermined location on the ground 102 or the legs 142 of the staple 140 inserted into the staple device 100 may be used to direct the irrigation tube to a desired position on the ground; and driving the piston 110 downward with forced generated by the user until the spring 130 is fully compressed.

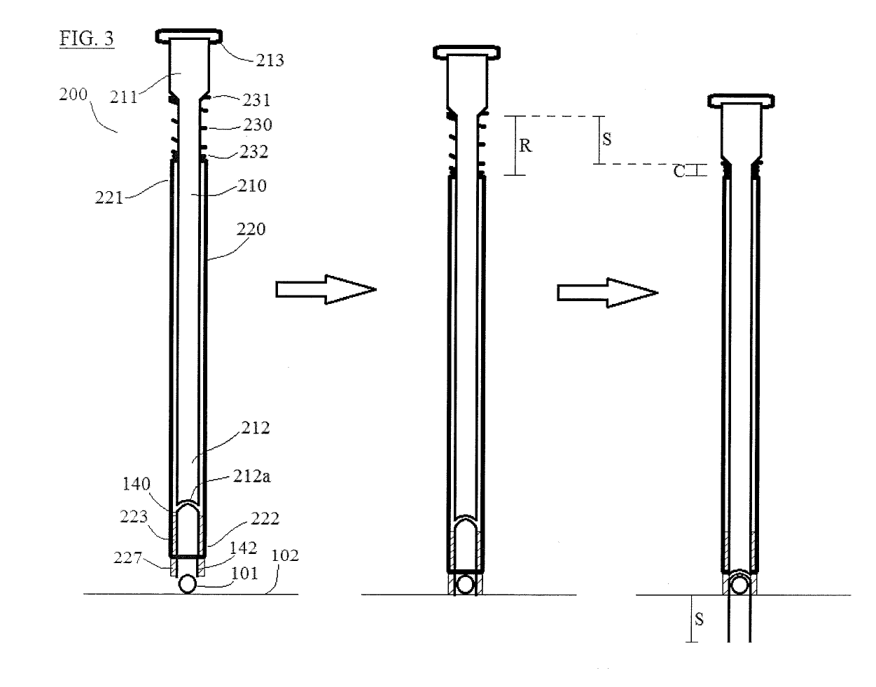

Without limiting the invention, FIG. 3 illustrates cross-section views of an embodiment of an irrigation staple device 200 and a method for using the irrigation staple device 200. In some embodiments, the irrigation staple device 200 may comprise: a piston 210 with a proximal portion 211 and a distal portion 212, the proximal portion 211 having a handle 213; a chamber 220 with a cylindrical passage 220a running from a proximal end 221 to a distal end 222, the distal end 222 having a staple guide 223 with grooves for holding a staple 140; and a spring 230 with an proximal end 231 and a distal end 232, the spring 230 being positioned between the piston 210 and the chamber 220. The function and method of use of the staple insertion device 200 may be substantially similar to the function and method of irrigation staple device 100, as discussed above.

The distal end 222 may further comprise a foot 227 diametrically positioned at the distal end of the chamber 220 such that the feet 227 are aligned with the staple guide 223. The feet 227 may have a length substantially equal to an outer diameter of an irrigation tube 101, such that the feet 227 contact the ground 102 when the staple device 200 is placed over the irrigation tube 101 and prevent the distal end 222 of the chamber 220 from pinching the irrigation tube 101 as the piston 210 is driven downward.

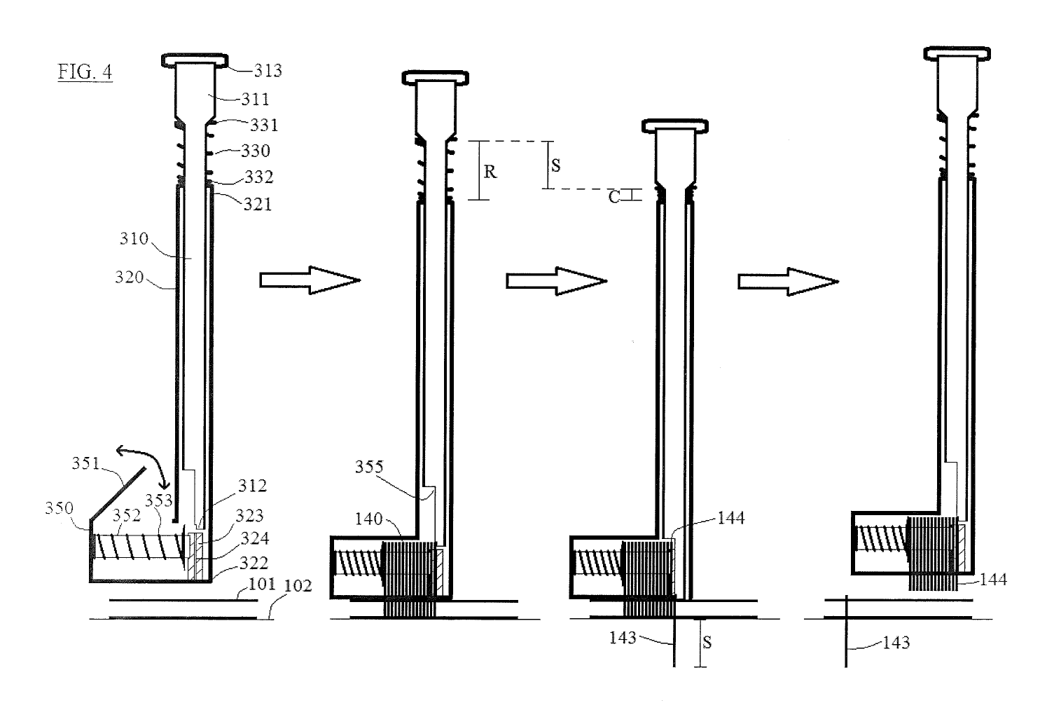

Without limiting the invention, FIG. 4 illustrates cross-section views of an embodiment of an irrigation staple device 300 and a method for using the irrigation staple device 300. In some embodiments, the irrigation staple device 300 may comprise: a piston 310 with a proximal portion 311 and a distal portion 312, the proximal portion 311 having a handle 313; a chamber 320 having a cylindrical passage therethrough running from a proximal end 321 to a distal end 322, the distal end 322 having a staple guide 323 with grooves 324 for holding a staple 140; and a spring 330 with an upper end 331 and a lower end 332, the spring 330 being positioned between the piston 310 and the chamber 320.

The chamber 320 may further comprise a housing 350 for holding a plurality of staples 140, the housing 350 comprising an access door 351 for accessing the housing 350 and depositing the plurality of staples 140, a central support 352 for holding and directing the plurality of staples 140 toward the staple guide 323, and a lateral spring 353 to push the plurality of staples 140 along the central support 352 and toward the staple guide 323. In some embodiments, as the distal end 312 of the piston 310 retreats proximally away from the distal end 322 of the chamber 320 after driving a first staple 143 of the plurality of staples 140 (which may be bound in a strip) into the ground 102, the lateral spring 353 may push a second staple 144 of the plurality of staples 140 into position in the staple guide 323, allowing the staple device 300 to set the second staple 144 without the installer having to place the second staple 144 into the staple guide 323 manually.

The distal end of the piston 310 may have a specialized shape for accommodating the plurality of staples 140. For example, the distal end of the piston 310 may have a recess 35 that accommodates and does not disturb the position of the pentultimate staple in the plurality of staples as the piston 310 is driving the ultimate staple into the ground. The recess 355 may allow the staples to be loaded smoothly into the guide without jamming the staple insertion device.

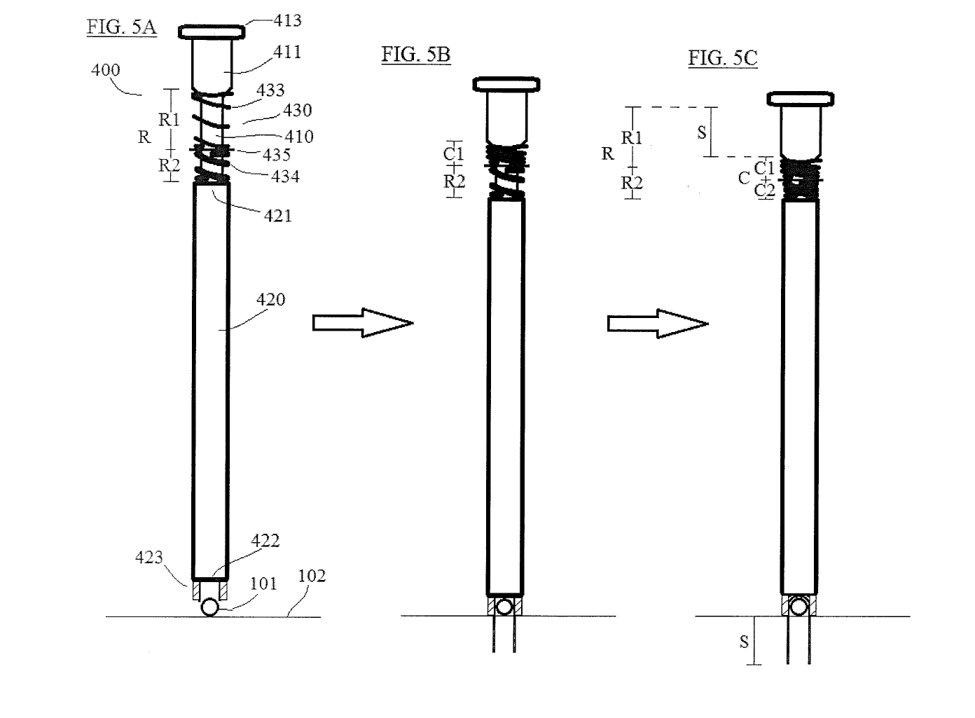

Without limiting the invention, FIG. 5A-5C illustrate side-views of an embodiment of an irrigation staple device 400 and a method for using the irrigation staple device 400. In some embodiments, the irrigation staple device 400 may comprise: a piston 410 with a proximal portion 411, the proximal portion 411 having a handle 413; a chamber 420 having a cylindrical passage therethrough running from a proximal end 421 to a distal end 422, the distal end 422 having a staple guide 423 for holding a staple 140 in place in the chamber 420; and a spring 430 with a first stage 433 and a second stage 434 separated by and a separating ring 435, the spring being positioned between the piston 410 and the chamber 420.

In some embodiments, the first stage 433 may have a lower compression rating than the second stage, such that upon providing a downward force on the handle 413, the first stage 433 transitions from a resting length R1 to a compressed length C1 (see FIG. 5B) before the second stage 434 transitions from a resting length R2 to a compressed length C2 (see FIG. 5C). The difference between the resting length R of the full spring 430 (being the sum of R1 and R2) and the compressed length C of the full spring (being the sum of C1 and C2) may thus equal the stroke length S of the piston 410 (see FIG. 5C).

In such embodiments, if the downward force applied to the handle 413 is consistent throughout the stroke length S of the piston 410, the piston 410 will travel more slowly after the first stage 433 is fully compressed, and the second stage 434 is still being compressed. As a result, the piston 410 will travel more slowly at the end of the stroke S than at the beginning of the stroke S, allowing a user to recognize when the piston 410 is nearing the end of the stroke S and reduce the force on the handle 413 to help prevent pinching of the irrigation tube.

The user of the staple insertion tool may use the plurality of staples to guide, position, or reposition the irrigation tubing as the user moves along the tubing inserting successive staples. This embodiment allows the user to move quickly along the irrigation tubing inserting staples without the user having to reload the staple insertion tool for several insertions.

### Conclusion/Summary

The present invention provides a device and methods for setting staples over an irrigation tube for use in drip irrigation. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A device for driving a staple into the ground, the device comprising:
a. a piston with a proximal portion and a distal portion;
b. a chamber with a proximal end and a distal end, and a passage in which the distal portion of the piston is slidably positioned; and
c. a spring positioned between said proximal portion of said piston and said proximal end of said chamber.

2. The device of claim 1, wherein a distance said staple is driven into the ground is defined by a stroke length of said piston.

3. The device of claim 2, wherein said proximal portion of said piston comprises a shoulder having an outer diameter greater than an outer diameter of said distal portion, and greater than an inner diameter of said passage.

4. The device of claim 3, wherein a proximal end of said spring is in contact with said shoulder of said proximal portion of said piston and a distal end of said spring is in contact with a shoulder of said proximal end of said chamber.

5. The device of claim 2, wherein said stroke length is defined by a difference between a resting length of said spring and a compressed length of said spring.

6. (canceled)

7. (canceled)

8. The device of claim 1, wherein said distal end of said chamber comprises a staple guide in said passage for receiving at least one staple.

9. The device of claim 8, wherein said staple guide comprises two grooves in an inner surface of said passage, said two grooves being positioned on opposite lateral sides of said inner surface of said passage and each being capable of holding a leg of said staple in substantial alignment with a central axis of said chamber.

10. (canceled)

11. The device of claim 1, wherein said chamber comprises at least one spacer foot, said spacer foot comprising a length substantially equal to an outer diameter of an irrigation tube.

12. (canceled)

13. The device of claim 1, wherein said chamber comprises a housing for holding a plurality of staples.

14-21. (canceled)

22. The device of claim 2, wherein said spring has a plurality of stages, each stage comprising a different spring constant.

23. The device of claim 22, wherein said plurality of stages comprises a first stage having a first spring constant, and a second stage having a second spring constant, said second spring constant being greater than said first spring constant.

24-37. (canceled)

38. A device for driving a staple into the ground, the device comprising:
a. a piston with a proximal portion and a distal portion;
b. a barrel with a proximal end and a distal end, and a passage in which the distal portion of the piston is slidably positioned, said barrel having a slot positioned said distal end for positioning a staple for holding an irrigation tube to the ground; and
c. a cushioning mechanism positioned between said proximal portion of said piston and said proximal end of said barrel.

39. The device of claim 38, wherein a distance said staple is driven into the ground is defined by a stroke length of said piston.

40. (canceled)

41. The device of claim 38, wherein said cushioning mechanism prevents the piston from advancing beyond a pre-determined point in said barrel.

42. The device of claim 38, wherein said slot comprises two grooves in an inner surface of said passage, said two grooves being positioned on opposite lateral sides of said inner surface of said passage and each being capable of holding a leg of said staple in substantial alignment with a central axis of said chamber.

43. (canceled)

44. The device of claim 38, wherein said chamber comprises at least one spacer foot, said spacer foot comprising a length substantially equal to an outer diameter of an irrigation tube.

45. (canceled)

46. (canceled)

47. (canceled)

48. A device for driving a staple into the ground, the device comprising:
a. a staple driving mechanism that includes a staple driver having a staple driving portion and a handle;
b. a barrel with a proximal end and a distal end, and a passage in which said staple driving portion is slidably positioned, said barrel having a slot positioned said distal end for positioning a staple for holding an irrigation tube to the ground; and
c. a cushioning mechanism positioned between said staple driving portion of said staple driver and said proximal end of said barrel that prevents said driving portion from penetrating said passage beyond a pre-determined point in said barrel.

49. The device of claim 48, wherein a distance said staple is driven into the ground is defined by a stroke length of said piston.

50. The device of claim 48, wherein said slot comprises two grooves in an inner surface of said passage, said two grooves being positioned on opposite lateral sides of said inner surface of said passage and each being capable of holding a leg of said staple in substantial alignment with a central axis of said chamber.

51. (canceled)

52. The device of claim 48, wherein said chamber comprises at least one spacer foot, said spacer foot comprising a length substantially equal to an outer diameter of an irrigation tube.

53-55. (canceled)
